(19) United States
(12) Patent Application Publication
(10) Pub. No.: US 2007/0128510 A1
(43) Pub. Date: Jun. 7, 2007

(54) Voltaic element

(75) Inventors: Rainer Hald, Ellwangen (DE); Johannes Maier, Ellwangen (DE); Peter Haug, Ellwangen (DE); Wolf-Ulrich Barenthin, Ellwangen (DE); Heinrich Stelzig, Rosenberg (DE); Peter Birke, Ellwangen (DE); Dejan Ilic, Ellwangen (DE)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Varta Microbattery GmbH, Hannover (DE)

(21) Appl. No.: 10/583,178

(22) PCT Filed: Dec. 16, 2004
(86) PCT No.: PCT/EP04/14332

§ 371 Date: Oct. 10, 2006

(30) Foreign Application Priority Data
Dec. 18, 2003 (DE) 103 61 360.9

(51) Int. Cl. H01M 4/66; H01M 2/02; H01M 10/50

(52) U.S. Cl. 429/127; 429/245; 429/231.95; 429/62; 429/176

(57) ABSTRACT

A voltaic element including at least one lithium intercalating electrode and a housing including flexible film material through which diverters connected to positive and negative electrodes of the element are conducted exteriorly, wherein the diverter connected to the collector of the negative electrode and conducted to the exterior includes nickel-coated copper foil.

The subject matter of the invention is a voltaic element comprising at least one lithium intercalating electrode and a housing consisting of flexible film material through which diverters connected to the positive and negative electrodes of the element are conducted to the exterior.

Rechargeable lithium cells with a flexible film housing (soft pack) are increasingly used in portable high-tech devices such as mobile telephones, PDAs and organizers due to their high energy density and the resultant low weight.

Because of the ever progressing miniaturization of these devices, the space available for the energy store also continuously decreases. At the same time, however, the demands on the cells with regard to load carrying capability and performance, for example in GSM, GPRS, UMTS, continuously increase. In these applications, the cells are exposed to ever greater pulse loading and the voltage must not drop below a predetermined or device-specific turn-off voltage.

To meet these requirements, these cells must have, among other things, a very low internal impedance.

Lithium polymer cells are constructed, for example, in such a manner that a number of electrodes are stacked and the respective collectors of the (negative) anodes and (positive) cathodes, respectively, are connected in parallel by welding and are connected to a diverter leading to the exterior. The collector material used in the cathode is aluminum (expanded metal or foil which can be additionally perforated in any form) and it is copper (expanded metal or foil which can be additionally perforated in any form) in the anode. Nickel is used for the diverter of the anode leading to the exterior and aluminum is used for the diverter of the cathode leading to the exterior.

Document EP 1 291 934 A2 describes a cell in soft pack which can be highly stressed mechanically. The diverter material mentioned is, for example, aluminum, copper, phosphorous bronze, nickel, titanium, iron and refined steel and alloys of these. Furthermore, a possible following “soft annealing” is mentioned and possible coating of the diverters with a polymer, a phosphate compound, a titanium compound or a zinc phosphate for increasing the adhesion is described. As can be seen from the examples, nickel is preferably used as the material for the negative diverter.

The document U.S. Pat. No. 6,045,946 discloses lithium polymer cells with a soft pack housing which has diverters of nickel-plated steel, aluminum foil or copper foil leading to the exterior.

The printed document EP 1 276 161 A1 describes a corrosion-resistant coating for diverters of a lithium ion cell in soft pack which consists of phosphate/chromate etc. The material proposed for the diverters is aluminum, nickel, refined steel and copper.

The invention is based on the object of specifying a voltaic element of the type initially mentioned which has a very low overall resistance and is thus particularly suitable for high pulse loading.

According to the invention, this object is achieved by a voltaic element having the features of claim 1 or of claim 2. Advantageous and preferred embodiments of the invention can be found in the subclaims.

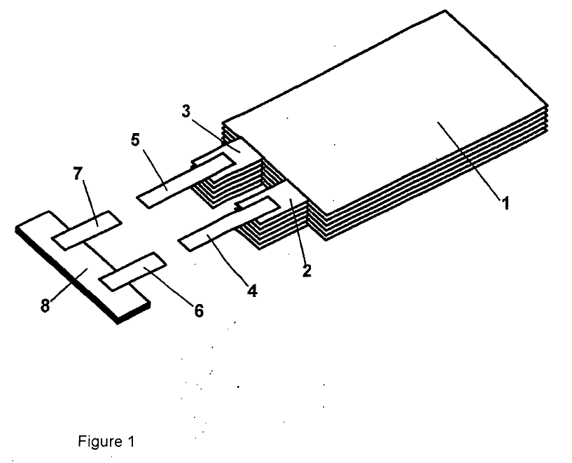

FIG. 1 shows the diagrammatic structure of a lithium polymer cell in stacked technology, which is provided with safety electronics.

The positive collectors 3 of the stacked electrodes 1 are welded to the positive diverter 5. The negative collectors 2 are welded to the negative diverter 4. The diverters 4, 5 of the cell are welded to the corresponding diverters 6, 7 of the safety electronics 8.

The housing (soft pack of compound aluminum/plastic film) of the cell which encloses the electrodes 1 and the collectors 2, 3 and through which the diverters 4, 5 are conducted to the exterior is not shown.

In the diverter 4 consisting of nickel-plated copper according to the invention, the positive characteristics of two materials are combined in such a manner that the negative characteristics of the individual materials are eliminated; namely the electrically highly conductive copper is provided with a thin corrosion-resistant electrolyte-resistant easily weldable layer of nickel. The copper provides good electrical conductivity; the surface nickel-plating ensures that all other requirements such as corrosion-resistance, electrolyte-resistance and weldability are met.

Although the nickel used as diverter material in known cells has many positive characteristics such as corrosion-resistance, good weldability and electrolyte resistance, it is a relatively poor electrical conductor so that the diverters of nickel provide a not inconsiderable proportion of the total resistance of the cell or of the battery pack, respectively, and thus have a negative influence on the load-carrying capability and performance. This negatively influences the voltage drop, especially with pulse loading of the cell so that the voltage drops below the turn-off voltage of the load connected to the cell or the battery pack earlier and the run time of the load is thus reduced.

The combination of materials used according to the invention is electrically more conductive but at the same time easily weldable or solderable and corrosion-resistant. This material can be easily connected to the collectors of the negative electrode(s), which consist of copper in most cases, by means of ultrasonic or resistance welding. This material, which can come into contact with electrolyte in the interior of the cell, is resistant to the electrolyte used in each case and electrochemically compatible with the overall system.

The copper is preferably coated with nickel in a voltaic process but can also be coated by means of a physical or chemical vapor deposition process. It is also possible to use a trimetal film with the sequence nickel-copper-nickel.

The nickel-coated copper diverters are 2 mm to 15 mm, preferably 3 mm to 5 mm wide and 20 μm to 200 μm, preferably 50 μm to 100 μm thick. The layer thickness of the nickel is 10 nm to 3 μm preferably 50 nm to 500 nm.

The diverters are generally cut as strips from nickel-plated copper film and the edge of the strip which is not nickel-plated does not bring about any disadvantages.

However, it is also possible to cut the copper film into strips before it is coated and then to apply the coating. In this case, the edge of the strip is then also coated with nickel.

Due to the high energy density and because of the inflammable and etching organic lithium electrolyte used, special safety precautions must be taken with Li cells (Li ion and Li polymer) so that the end user is not endangered even with inexpert handling of the cell.

For this reason, an electronic safety circuit is applied externally to rechargeable Li cells, which monitors the charging and discharging process and protects the cell against inexpert handling such as, for example, overloading, deep discharging or external short circuit.

This safety electronics 8 also has diverters 6, 7 which are electrically conductively connected to the diverters 4, 5 of the cell by welding or soldering. If necessary, a temperature-dependent resistor (PTC, so-called polyswitch) is additionally connected between safety electronics and cell. This is also electrically connected to a diverter of the cell and the safety electronics via additional diverters. These diverters, too, consist according to the invention of nickel-plated copper.

Such circuit arrangements can be found in the documents DE 101 04 981 A1 and DE 102 50 857 A1.

Depending on the type of cell and type of link-up of the safety electronics and possibly of the temperature-dependent resistor (PTC), considerable improvements in the total resistance can be achieved by replacing the known nickel diverters with nickel-plated copper diverters having the same dimensions, namely a reduction in the resistance by 12% for a single cell, a reduction by 9% for a battery pack with individual cell according to the prior art and link-up according to the invention of the safety electronics, and a reduction by 13% for a battery pack with a single cell according to the invention and link-up according to the invention of the safety electronics.

The values are exemplary for a current cell and battery pack type having the dimensions 66*35*4.2 mm³ and can be higher or lower in other types.

In the text which follows, actual values are calculated for a lithium cell having the dimensions 66*35*4.2 mm³ and a capacity of 900 mAh. For the diverters, the conductor resistance is calculated as follows:

$$R = \frac{l}{γ \times A}$$

where γ=conductivity of the conductor material
l=conductor length
A=conductor cross section
R=resistance of the conductor

Conductivity of various conductor materials:

$$γ = 56.0 \frac{m}{Ω \times {mm}^{2}}$$

Copper (99.9%):

$$γ = 10.5 \frac{m}{Ω \times {mm}^{2}}$$
Nickel (99.5%):

### EXAMPLE 1

Single cell according to the prior art:

internal resistance of the cell without anode diverter,

with cathode diverter=27 mΩ

diverter length=16.5 mm

diverter cross section=5.0 mm*70 μm=0.35 mm²

Resistance of the anode diverter of nickel:

$$R = \frac{0.0165 m}{10.5 \frac{m}{Ω \times {mm}^{2}} \times 0.35 {mm}^{2}} = 4.49 m Ω$$

Resistance of the anode diverter of copper:

$$R = \frac{0.0165 m}{56.0 \frac{m}{Ω \times {mm}^{2}} \times 0.35 {mm}^{2}} = 0.84 m Ω$$

According to the prior art (nickel diverter at the anode), such a cell has an internal resistance of
27+4.49 mΩ=31.49 mΩ
According to the invention (nickel-plated copper diverter at the anode), such as a cell has an internal resistance of
27+0.84 mΩ=27.84 mΩ
This results in an improvement of the resistance of the pure cell of 11.6%.

### EXAMPLE 2

Single cell with safety electronics according to the prior art or single cell according to the prior art and link-up according to the invention of the safety electronics

Internal resistance of the cell with anode

diverter of nickel=31.49 mΩ

resistance of the safety electronics=40 mΩ

resistance of the PTC=20 mΩ

Diverter for electronics and PTC assembly:

2 diverters of type 1 (electronics—PTC connector; PTC —element diverter connector) with

diverter length=8.5 mm

diverter cross section=4.0 mm*70 μm=0.28 mm²

1 diverter of type 2 (electronics—element diverter connector) with

diverter length=17.0 mm

diverter cross section=4.0 mm*70 μm=0.28 mm²

Resistance of a diverter type 1 of nickel:

$$R = \frac{0.0085 m}{10.5 \frac{m}{Ω \times {mm}^{2}} \times 0.28 {mm}^{2}} = 2.89 m Ω$$

i.e. 5.78 mΩ for 2 diverters

Resistance of a diverter of type 1 of copper:

$$R = \frac{0.0085 m}{56.0 \frac{m}{Ω \times {mm}^{2}} \times 0.28 {mm}^{2}} = 0.54 m Ω$$

i.e. 1.08 mΩ for 2 diverters

Resistance of a diverter of type 2 of nickel:

$$R = \frac{0.017 m}{10.5 \frac{m}{Ω \times {mm}^{2}} \times 0.28 {mm}^{2}} = 5.78 m Ω$$

Resistance of a diverter of type 2 of copper:

$$R = \frac{0.017 m}{56.0 \frac{m}{Ω \times {mm}^{2}} \times 0.28 {mm}^{2}} = 1.08 m Ω$$

Such a battery pack
has an internal resistance of 31.49 mΩ+5.78 mΩ+5.78 mΩ+40 mΩ+20 mΩ=103.05 mΩ (cell+diverter for electronics and PTC+safety electronics+PTC) with a cell according to the prior art (nickel diverter at the anode) and nickel diverter for electronics link-up
has an internal resistance of 31.49 mΩ+1.08 mΩ+1.08 mΩ+40 mΩ+20 mΩ=93.65 mΩ (cell+diverter for electronics and PTC+safety electronics+PTC) with a cell according to the prior art (nickel diverter at the anode) and diverters according to the invention (nickel-plated copper diverters) for electronics link-up.

This results in an improvement of the internal resistance of the battery pack of 9%.

### EXAMPLE 3

Battery pack with single cell and electronics link-up according to the prior art or single cell and electronics link-up according to the invention, respectively.

Internal resistance of the cell with anode

diverter of nickel=31.49 mΩ

internal resistance of the cell with anode diverter of

copper=27.84 mΩ

resistance of the safety electronics=40 mΩ

resistance of the PTC=20 mΩ

diverters for electronics and PTC assembly:

2 diverters of type 1 with

diverter length=8.5 mm

diverter cross section=4.0 mm*70 μm=0.28 mm²

1 diverter of type 2 with

diverter length=17.0 mm

diverter cross section=4.0 mm*70 μm=0.28 mm²

Resistance of a diverter of type 1 of nickel:

$$R = \frac{0.0085 m}{10.5 \frac{m}{Ω \times {mm}^{2}} \times 0.28 {mm}^{2}} = 2.89 m Ω$$

i.e. 5.78 mΩ for 2 diverters

Resistance of a diverter of type 1 of copper:

$$R = \frac{0.0085 m}{56.0 \frac{m}{Ω \times {mm}^{2}} \times 0.28 {mm}^{2}} = 0.54 m Ω$$

i.e. 1.08 mΩ for 2 diverters

Resistance of a diverter of type 2 of nickel:

$$R = \frac{0.017 m}{10.5 \frac{m}{Ω \times {mm}^{2}} \times 0.28 {mm}^{2}} = 5.78 m Ω$$

Resistance of a diverter of type 2 of copper:

$$R = \frac{0.017 m}{56.0 \frac{m}{Ω \times {mm}^{2}} \times 0.28 {mm}^{2}} = 1.08 m Ω$$

This battery pack
has an internal resistance of 31.49 mΩ+5.78 mΩ+5.78 mΩ+40 mΩ+20 mΩ=103.05 mΩ (cell+diverter for electronics and PTC+safety electronics+PTC) according to the prior art (nickel diverters at the anode and for electronics link-up)
has an internal resistance of 27.84 mΩ+1.08 mΩ+1.08 mΩ+40 mΩ+20 mΩ=90 mΩ (cell+diverter for electronics and PTC+safety electronics+PTC) according to the invention (nickel-plated copper diverters at the anode and for electronics link-up)

This corresponds to an improvement in the internal resistance of the battery pack of 13%.

Due to the lower resistance, a considerable improvement of load-carrying capability and performance of the cell or of the battery pack, respectively, is achieved. Due to the lower resistance of cell or battery pack, respectively, the voltage drop is also less with pulse loading and high continuous loading as a result of which the voltage drops below the turn-off voltage of the connected load later which is reflected in a longer run time of the load.

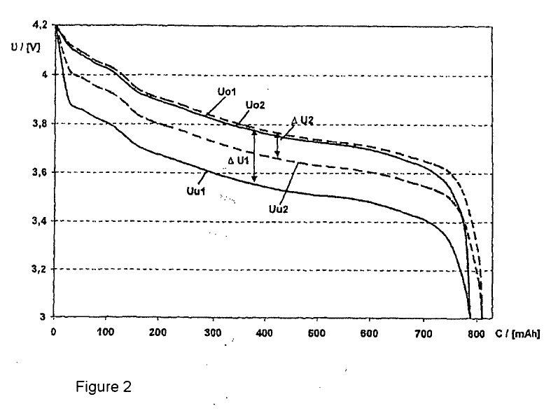

FIG. 2 shows by way of example the voltage variation of cells according to the prior art in comparison with cells constructed according to the invention with a discharge of GSM pulses (discharged: GSM/20° C. (up to 3.0 V) GSM pulse loading: 2 A/0.55 ms; 80 mA/4.05 ms)

Uo1 and Uu1 show the voltage variation as a function of the removed capacity of cells according to the prior art, where Uo1 reproduces the voltage variation of the pulse gap and Uu1 reproduces the voltage variation of the pulse. ΔU1 shows the resultant voltage.

Uo2, Uu2 and ΔU2 analogously show the corresponding variation in cells according to the invention.

The improvement in performance and load-carrying capability of the cells according to the invention can be clearly seen. A considerable improvement in the device run time can be achieved in dependence on the load-specific turn-off voltage.

1-9. (canceled)

10. A voltaic element comprising at least one lithium intercalating electrode and a housing comprising flexible film material through which diverters connected to positive and negative electrodes of the element and connected to safety electronics are conducted exteriorly, wherein at least one of the diverters which connect element and safety electronics comprises nickel-coated copper foil.

11. The voltaic element as claimed in claim 10, wherein a further protective element is inserted in the link between element and safety electronics.

12. The voltaic element as claimed in claim 11, wherein the further protective element is a PTC resistor.

13. The voltaic element as claimed in claim 10, wherein a further protective element is inserted in the link between element and safety electronics.

14. The voltaic element as claimed in claim 13, wherein the further protective element is a thermal fuse.

15. The voltaic element as claimed in claim 10, wherein the copper foil is voltaically nickel plated.

16. The voltaic element as claimed in claim 10, wherein the nickel-coated copper diverters are 2 mm to 15 mm wide.

17. The voltaic element as claimed in claim 10, wherein the nickel-coated copper diverters are 20 μm to 200 μm thick.

18. The voltaic element as claimed in claim 10, wherein the layer thickness of the nickel is 10 nm to 3 μm.

19. The voltaic element as claimed in claim 10, wherein the housing comprises a compound aluminum/plastic film.
